(19) United States
(12) Patent Application Publication
(10) Pub. No.: US 2024/0237614 A1
(43) Pub. Date: Jul. 18, 2024

(54) CANINE RETRIEVING TARGET THROWER

(71) Applicant: Dive Bomb Industries, LLC, Maryland Heights, MO (US)

(72) Inventors: Cody E. Stokes, St. Louis, MO (US); Thomas J. Dryer, Foley, MO (US)

(21) Appl. No.: 18/413,177

(22) Filed: Jan. 16, 2024

Related U.S. Application Data
(60) Provisional application No. 63/479,779, filed on Jan. 13, 2023.

(51) Int. Cl. A01K 15/02

(52) U.S. Cl. CPC A01K 15/025

(57) ABSTRACT

A canine retrieving training system and associated components and methods. The system can include a canine retrieving target comprising a target body and a target tether. The target tether can include a tie portion and an anchor. The system can include a target thrower comprising a handle and a throwing head. The throwing head includes a tether receiver for holding the tether and releasing the tether when the handle is moved in a throwing motion. For example, the tether receiver can comprise a pair of arms configured to receive the tether therebetween.

### CROSS-REFERENCE TO RELATED APPLICATION

The present application claims priority to U.S. Provisional Patent Application No. 63/479,779, filed Jan. 13, 2023, the entirety of which is hereby incorporated by reference.

### FIELD

The present disclosure generally relates to canine training tools, and more particularly to canine retrieving training tools.

### BACKGROUND

Various types of retrieving targets (sometimes called bumpers or dummies) are used to train canines to retrieve.

### SUMMARY

In one aspect, a canine retrieving training system comprises a canine retrieving target and a target thrower. The canine retrieving target comprises a target body and a target tether. The target tether is connected to the target body. The target thrower comprises a handle and a throwing head supported by the handle. The throwing head includes a tether receiver. The tether receiver is sized and shaped to receive the tether and configured to release the tether when the handle is moved in a throwing motion.

In another aspect, a canine retrieving target thrower is for throwing a canine retrieving target that includes a target body and a target tether. The thrower comprises a handle and a throwing head supported by the handle. The throwing head includes a tether receiver comprising a first arm and a second arm defining a slot therebetween for reception of the target tether. The tether receiver is configured to release the target tether from the slot when the handle is moved in a throwing motion.

In yet another aspect, a method of throwing a canine retrieving target comprises connecting a tether of the canine retrieving target to a thrower and moving the thrower in a throwing motion. Moving the thrower in the throwing motion comprises changing an angle of the tether with respect to a shaft of the thrower while the canine retrieving target is connected to the thrower, and releasing the tether from the thrower.

Other objects and features of the present disclosure will be in part apparent and in part pointed out herein.

### BRIEF DESCRIPTION OF THE DRAWINGS

FIG. 1 is a rear perspective of a canine retrieving training system of the present disclosure in which a user is holding and moving a thrower thereof to throw a retrieving target thereof;

FIG. 2 is a front perspective of the thrower of FIG. 1;

FIG. 3 is a fragmentary front perspective of the thrower showing a head thereof in closer detail;

FIG. 4 is a front view of the head of the thrower;

FIG. 5 is a rear perspective of the head of the thrower;

FIG. 6 is a rear view of the head of the thrower;

FIG. 7 is a left elevation of the head of the thrower;

FIG. 8 is a top view of the head of the thrower;

FIG. 9 is a front view of the retrieving target including a target body and target tether;

FIG. 10 is a front perspective of the head with the tether of the retrieving target installed on the head;

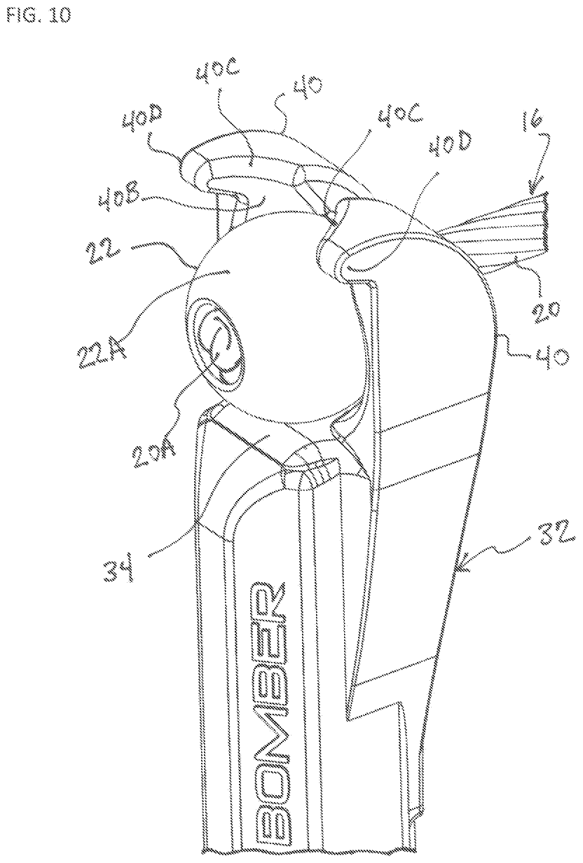

FIG. 11 is a rear perspective of the head and tether of FIG. 10;

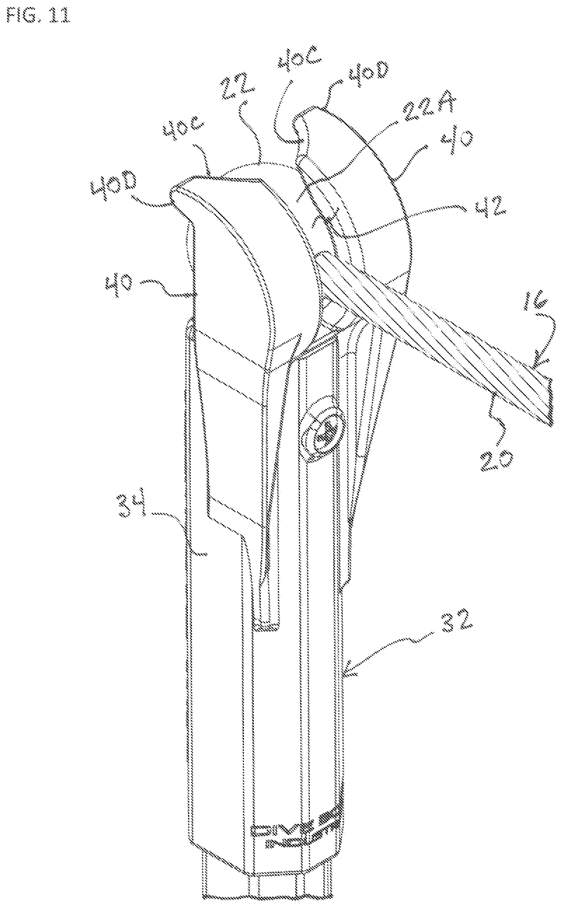

FIG. 12 is a side elevation of the target and thrower in a first orientation before the thrower is moved in a throwing motion;

FIG. 13 is a side elevation of the target and thrower in a second orientation while the thrower is being moved in a throwing motion;

FIG. 14 is a side elevation of the target and thrower in a third orientation while the thrower is being moved in a throwing motion and just prior to the retrieving target being released from the thrower; and

FIG. 15 is a perspective of the thrower being used as a retriever by connecting the head of the thrower to the target tether to pick up the retrieving target.

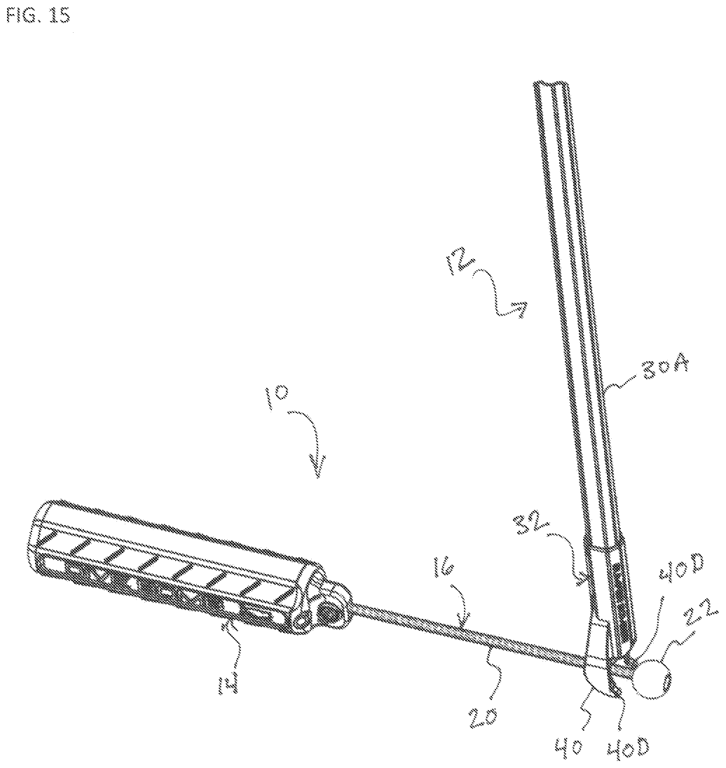

Corresponding reference numbers indicate corresponding parts throughout the drawings.

### DETAILED DESCRIPTION

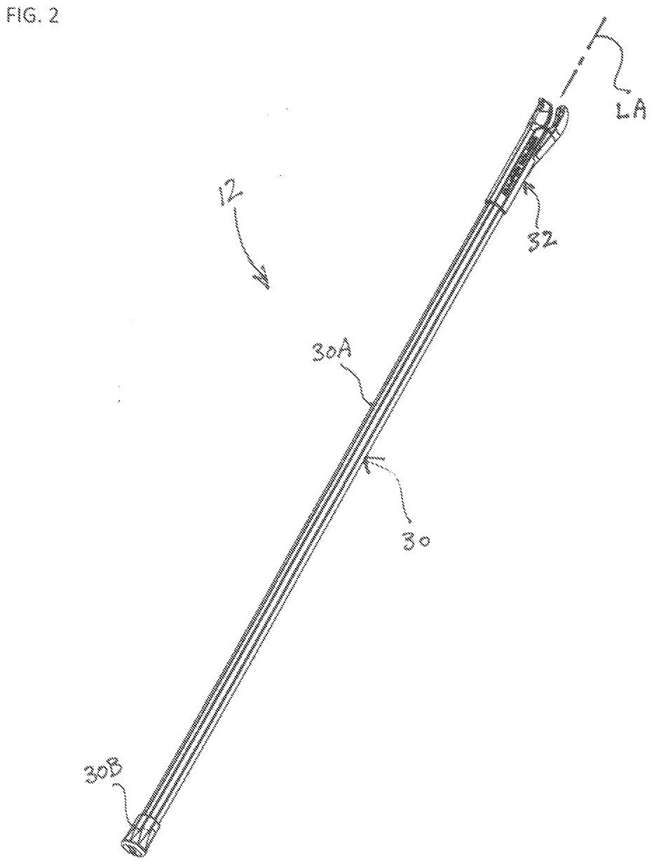

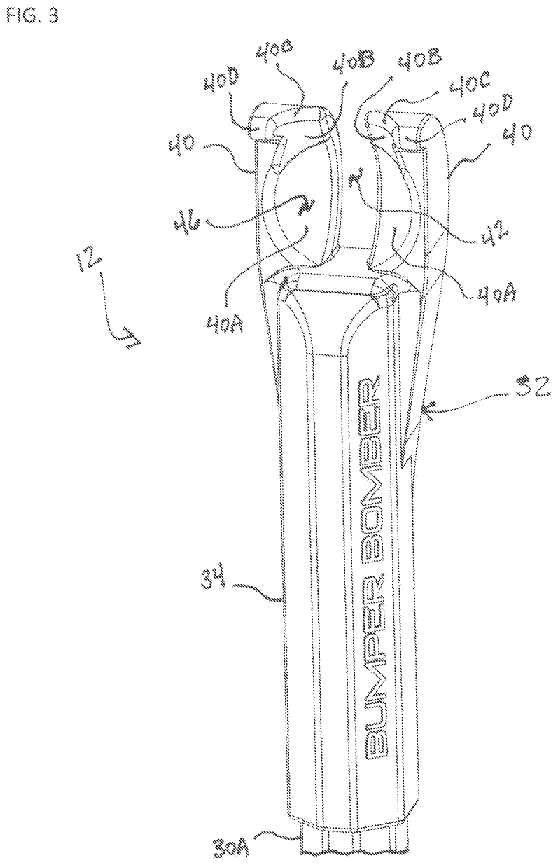

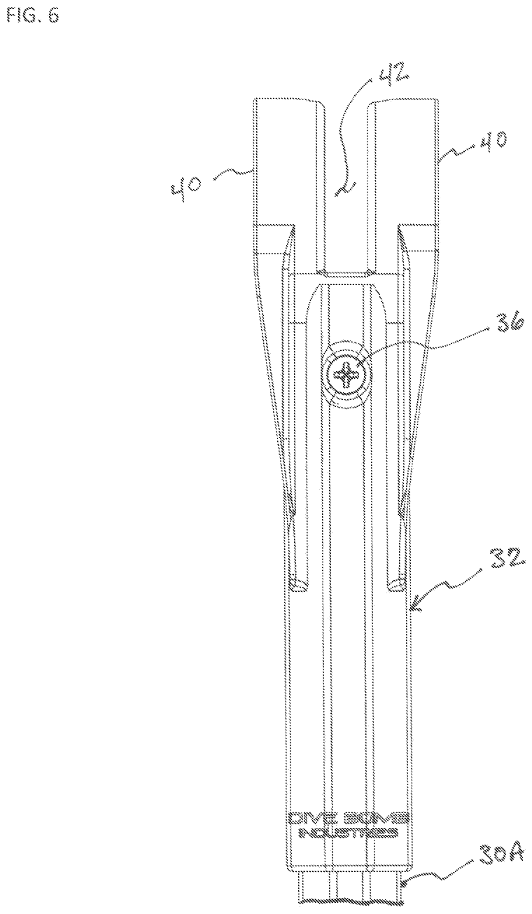

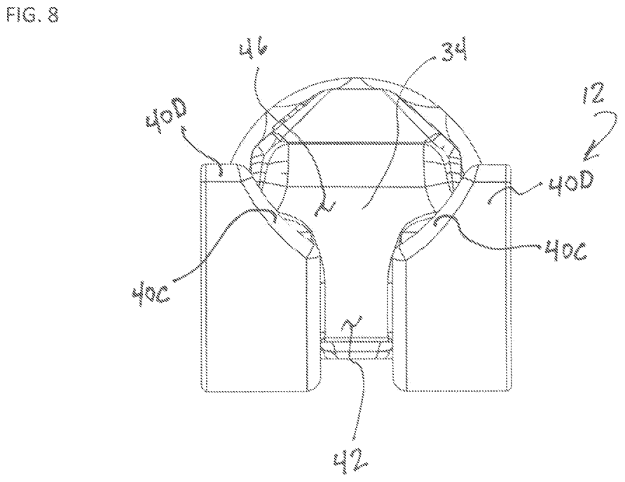

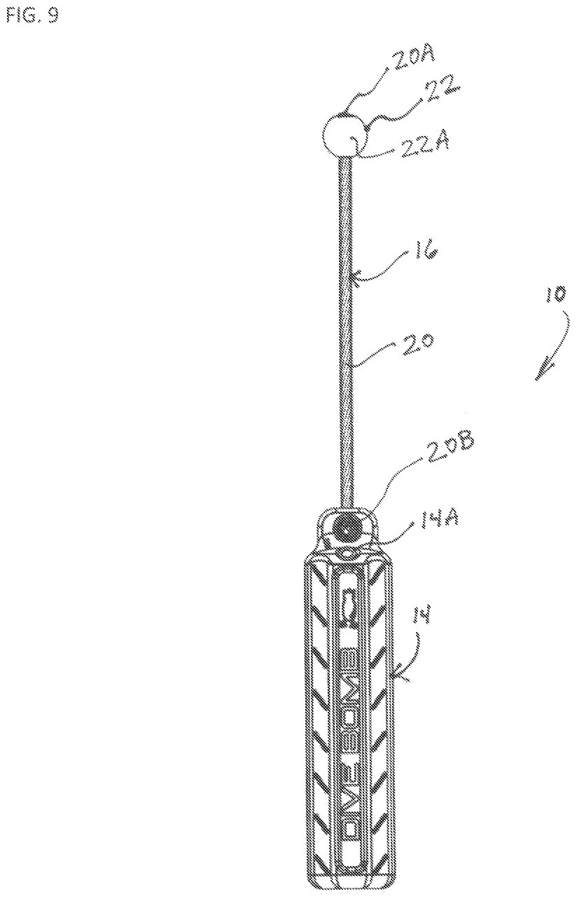

The present disclosure is directed to a system for training canines to retrieve. The system includes a retrieving target 10 (e.g., FIG. 9) and a thrower 12 (e.g., FIGS. 2-8) configured to throw the retrieving target. In general, the user may throw the target 10 using the thrower 12, receive the target from a canine that has retrieved and returned the target, and then throw the target again to repeat the process for training and/or exercising the canine. For example, the target 10 may be thrown on land or in water to train a canine to retrieve in various scenarios.

Referring to FIG. 9, the target 10 will be described in more detail. The target may be referred to as a bumper, a dummy, or a trainer, etc. The target 10 includes a target body 14 and a tether 16 connected to the target body. The target body 14 is intended to be grasped by the mouth of the canine for retrieving the target. In the illustrated embodiment, the target body 14 has a generally elongate cylindrical shape, but other shapes and configurations can be used without departing from the scope of the present disclosure. For example, the target body 14 may be configured to have a shape that imitates a waterfowl (e.g., duck). In the illustrated embodiment, the target body 14 has a hollow interior. The target body can be made from a somewhat flexible polymeric material to permit deformation of the target body in a mouth of the canine. Other suitable materials and configurations can be used.

The target body 14 includes a port or valve 14A to permit the user to introduce water to the interior of the target body. Water in the target body allows the user to adjust the weight of the target body for better distance or to fight windy conditions. The amount of water in the target body can be adjusted to control how much of the target body is exposed when it is thrown into and floating in water. The more water in the target body 14 the less visible the target body will be to the dog when doing water retrieves. This mimics a wounded duck on the water as the duck will swim with its head at or below the water surface as an escape mechanism. Moreover, in some instances, the port or valve may be used to fill the body to a desired air pressure giving the target body a desired firmness.

In the illustrated embodiment, the tether 16 includes a cord 20 (broadly, tie portion) and an anchor 22. The cord 20 is shown as a piece of flexible rope and includes a first end connected (e.g., via a knot 20B) to a connector (e.g., eyelet) of the target body 14 and includes a second end portion connected to the anchor 22. In the illustrated embodiment, the anchor 22 comprises a generally spherical or ball-shaped anchor body having a passage therethrough. The anchor 22 is connected to the cord 20 by reception of the cord through the passage. The anchor is retained on the cord 20 by a knot 20A in the end of the cord resting on a shoulder of the anchor in the passage. The knot 20A is too large to pass through the passage at the shoulder and therefore maintains the anchor on the cord 20. Desirably, the knot 20A is received in the passage and does not substantially protrude from the anchor 22 to facilitate pivoting of the anchor on the thrower 12, for reasons which will become apparent. Other configurations of tethers can be used without departing from the scope of the present disclosure. For example, the cord can comprise a chain, cable, or other type of tie. In some embodiments, the tie may not be flexible. Moreover, the anchor can be provided in other forms, such as a knot or loop (e.g., a portion of the tie), or as a bracket, fitting, connector, etc.

The thrower 12 comprises a handle 30 and a throwing head 32. The handle 30 includes a shaft 30A (e.g., aluminum or steel shaft) having a proximal end portion, an opposite distal end portion, and a length extending therebetween. The shaft has a longitudinal axis LA. In the illustrated embodiment, the shaft 30A has a generally octagonal cross-sectional shape. However, other shapes (e.g. circular, oval, etc.) are not outside the scope of this disclosure. The handle 30 includes a butt cap 30B on the proximal end of the shaft 30A. A user may grip the thrower 12 along the shaft 30A and/or at the butt cap 30B in use.

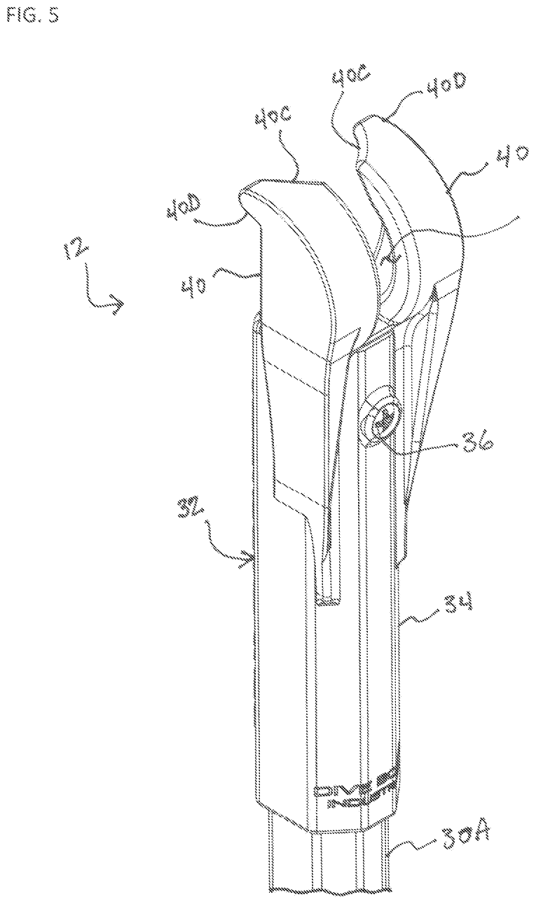

The head 32 is connected to the distal end of the shaft 30A. The head 32 includes a base portion 34 (broadly, connector) including an opening configured to receive the distal end of the shaft 30A to connect the head to the shaft. A fastener 36 (FIG. 5) passing through the base portion 34 into the shaft 30A can be used to secure the head to the shaft. Other types of throwing heads and other ways of connecting the head to the shaft (e.g., integral connection) can be used without departing from the scope of the present disclosure.

The head 32 includes first (left) and second (right) arms 40 extending distally from the base 34 of the head. The arms 40 together define a tether receiver (or tether holder) configured to receive and hold the tether 16 of the target 10 and configured to release the tether (and thus throw the target) when the handle is moved by a user in a throwing motion. The arms 40 are spaced from each other to define a slot 42 therebetween. The slot 42 is closed at a proximal end by the base portion 34 and is open at its distal end. The slot 42 is sized to permit the cord 20 of the tether 16 to be received between the arms 40. The slot 42 defines a track along which the cord 20 moves while being thrown from the thrower 12.

The arms 40 also form an anchor holder that defines an anchor recess 46 in front of the slot 42 that is sized and shaped to receive the anchor 22 when the cord 20 is in the slot 42. Each arm 40 has a concave arcuate surface portion 40A, and together the concave arcuate surface portions form a generally cup shape providing the anchor recess 46 with a generally semi-spherical shape (e.g., approximating a portion of a sphere). When the anchor 22 is in the anchor recess 46, the anchor is in registration with the longitudinal axis LA of the shaft 30A such that a mid-portion of the anchor is intersected by the longitudinal axis. The arrangement is such that the anchor 22 and anchor recess 46 form a connection similar to a ball and socket. The fit of the anchor 22 in the anchor recess 46 facilitates pivoting of the target 10 with respect to the thrower 12. For example, when the anchor 22 is received in the anchor recess 46 and the cord 20 extends through the slot 42, the cord can move distally in the slot and such motion is facilitated by the anchor being pivotable in the anchor recess. Desirably, the anchor 22 includes a convex arcuate outer surface 22A (e.g., such as on the generally spherical illustrated anchor) that promotes sliding of the anchor against the concave arcuate surfaces 40A of the arms 40. The pivoting of the target 10 with respect to the thrower 12 is helpful to reduce interference (e.g., friction) between the anchor and throwing head 32 to promote throwing of the target from the thrower. The anchor 22 and anchor recess 46 can have other shapes and configurations without departing from the scope of the present disclosure. For example, in some embodiments, the anchor may not be permitted to pivot with respect to the throwing head.

The arms 40 each include an exit ramp 40B configured to promote the anchor 22 to exit the anchor recess 46 as the thrower 10 is moved in the throwing motion. The exit ramps 40B are located on the arms 40 at a distal end of the anchor recess 46, spaced distally from the base 34 of the throwing head 32. The exit ramps 40B provide a deviation from the shape of the anchor recess 46 to facilitate dislodging the anchor 22 from the anchor recess 46 when the target is to be released from the throwing head.

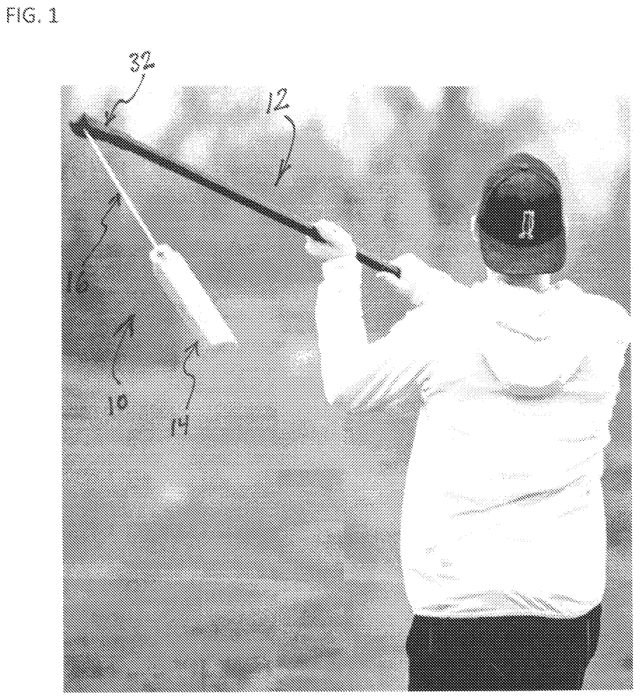

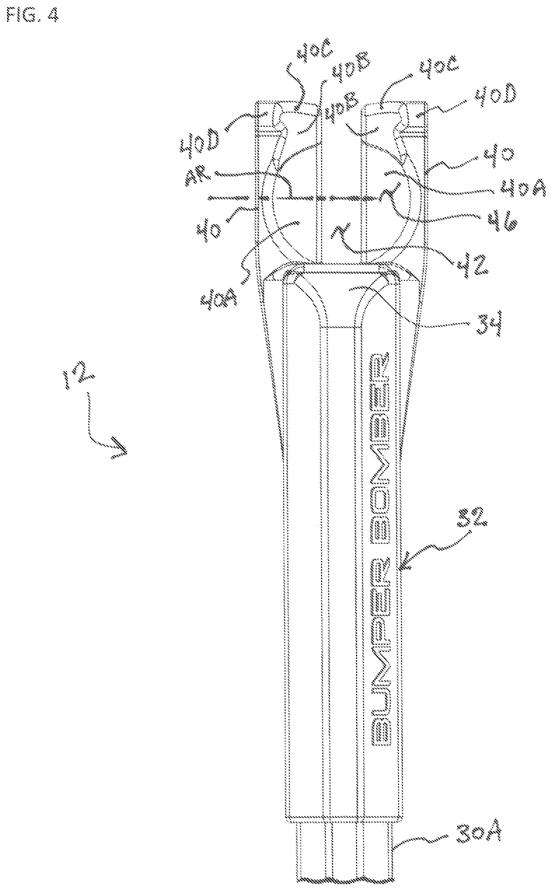

To throw the retrieving target 10, the user picks up the thrower 12 and arranges the anchor 22 in the anchor recess 46 with the cord 20 passing rearward through the slot 42 of the throwing head 32. The target body 14 hangs by the cord 20 from the throwing head 32. As shown in FIG. 1, the user can place one hand on a lower portion of the thrower 12 (e.g., at or near the butt cap 30B) and the other hand on an upper portion of the thrower relative to the lower portion. While holding the thrower 12, the user positions their hands about shoulder high such that the suspended retrieving target 10 is located behind the head or shoulder of the user. The user can then rapidly manipulate the thrower 12 in a forward throwing motion to use the thrower to generate mechanical advantage and to release the target 10 from the thrower in a forward direction. In doing so, the upper hand moves forward, and the lower hand remains generally still, or moves downward/rearward, serving substantially as a fulcrum about which the thrower is pivoted. The thrower 12 serves as a lever arm permitting the user to throw the target a substantial distance (e.g. 60-80 yards). In a throwing motion of the thrower 12, the ball-in-socket configuration of the anchor 22 and anchor recess 46 permits the anchor to rotate in the anchor holder and the target body to move upward and away from the shaft 30B of the thrower 12. The slot 42 between the arms 40 permits the cord 20 to move upward to permit rotation of the anchor 22 in the anchor recess 46. The anchor rotates in the recess about an axis of rotation AR (e.g., FIG. 4). The configurations of the anchor recess 46 and exit ramps 40B are such that they provide a generally high launch angle for throwing the retrieving target 10.

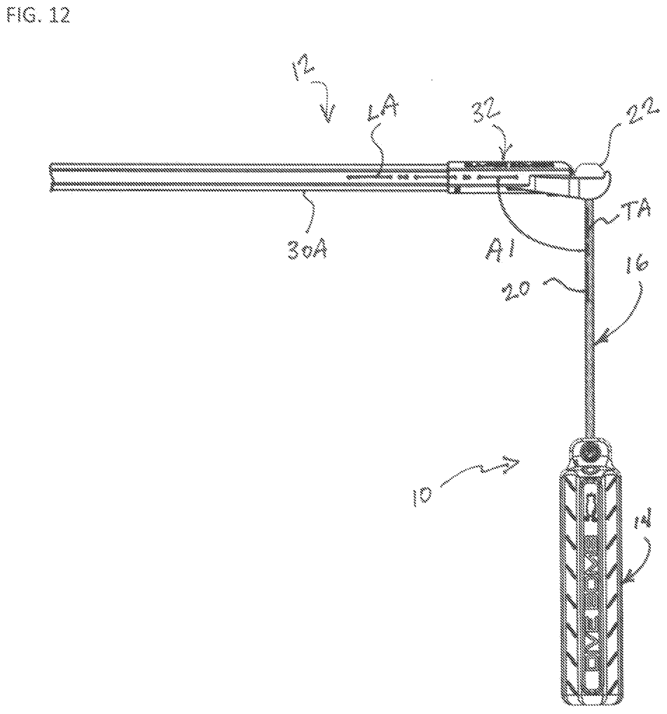

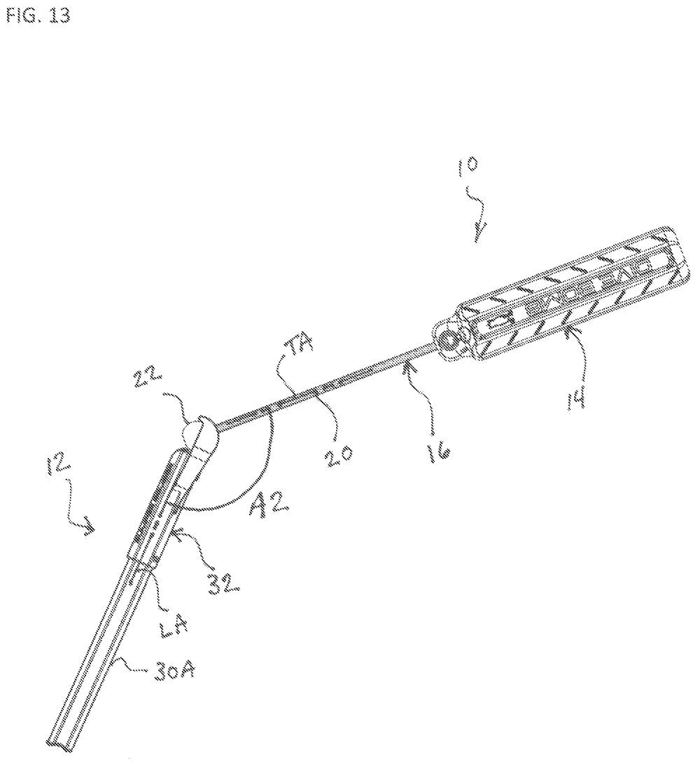

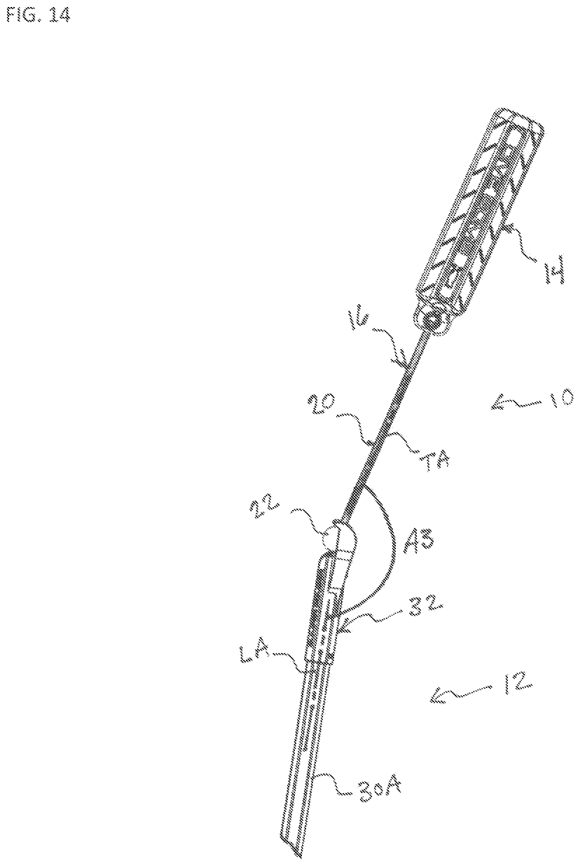

FIGS. 12-14 represent an example sequence of moving the thrower 12 in a throwing motion to impart throwing force on the target 10 and eventually release the target to throw the target. In this process, the target 10 pivots relative to the thrower 12 thus changing an orientation of the target with respect to the thrower. FIG. 12 represents an orientation the target 10 may have with respect to the thrower 12 when the user is preparing to throw the target. The user is holding the thrower 12 with the thrower head 32 and target 10 behind the user. For example without limitation, a target tether axis TA extends at an angle A1 of about 90-110 degrees with respect to the longitudinal axis LA. The starting orientation of the target 10 with respect to the thrower 12 will vary by user. FIG. 13 illustrates the target 10 at a second orientation in which the thrower 12 has been pivoted so the head 32 is moving upward and forward. The target body 14 moves upward relative to the head 32, the anchor 22 rotates in the anchor recess 46, and the cord 20 moves upward in the slot 42. The angle between the cord 20 and thrower shaft 30A increases as the user manipulates the thrower to throw the target. For example without limitation, in FIG. 13, the tether axis TA extends at an angle of about 111-150 degrees with respect to the longitudinal axis LA. FIG. 14 illustrates the retriever target 10 at a third position in which the anchor 22 has further rotated in the anchor recess 46, the cord 20 has moved farther up in the slot 42, and the tether axis TA extends at an angle A3 of about 140-170 degrees with respect to the longitudinal axis LA. FIG. 14 represents the orientation of the target 10 with respect to the thrower immediately prior to launch (e.g., just before the anchor 22 dislodges from the anchor recess 46). The exit ramps 40B cause dislodgment of the anchor 22 from the anchor recess 46 under the centrifugal force on the target body 14. For example without limitation, the angle A3 of the tether axis TA with respect to the shaft longitudinal axis LA at which the anchor 22 exits the anchor recess 46 may be in the inclusive range of about 130 to about 180 degrees, about 140 degrees to about 175 degrees, about 145 degrees to about 170 degrees, or about 145 to about 165 degrees.

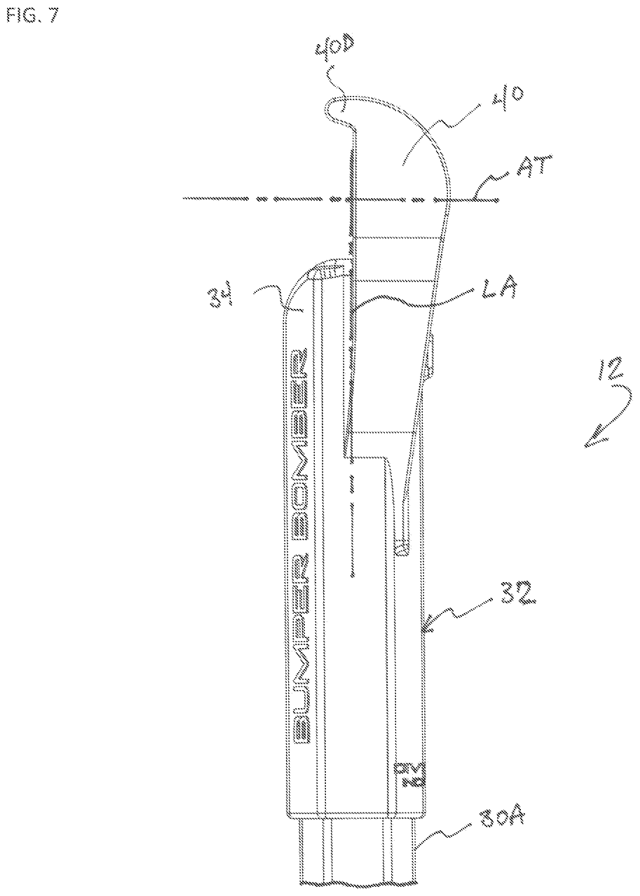

In another aspect, the thrower 12 is configured to assist the user in picking up the target 10. When the target 10 is resting on the ground, the user can manipulate the thrower 12 to position the two arms 40 of the thrower head 32 on opposite sides of the tether 16 such that the cord 20 is received in the slot 42 between the arms. The distal ends of the arms include tether guide ramps 40C defining a mouth that leads to the slot 42. The guide ramps 40C taper toward each other as they extend toward the slot 42 to assist in collecting and guiding the cord 20 of the tether 16 into the slot. Forward protruding fingers 40D are provided at the distal ends of the arms 40. The fingers 40D extend forward in a direction generally perpendicular to the longitudinal axis LA, and generally parallel to a transverse axis AT (FIG. 7) that is transverse to the longitudinal axis. With the cord 20 between the arms 40, the user advances the arms toward the anchor 22. The fingers 40D on the ends of the arms 40 reach under the anchor 40 and assist in directing the anchor into the anchor recess 46. The user then moves the head 32 of the thrower 12 upward with the anchor 22 in the anchor recess 46. Accordingly, the retrieving target 10 may be installed on the tether receiver from the ground without the user bending over or touching the retrieving target by hand. For example, when a dog returns the target 10 to the user, the dog may drop the target on the ground. The user can pick up the target 10 with the thrower head 32 and throw the target again.

It is appreciated that the person of ordinary skill in the art is readily able to determine the scope of terms of degree such as, but not limited to, “about,” “substantially,” and “generally.” For example, when a term of degree is used in relation to a numeric value, the person of ordinary skill in the art understands that the term of degree covers an inclusive range of plus or minus 10% of the numeric value, unless clearly indicated or stated otherwise.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

Modifications and variations of the disclosed embodiments are possible without departing from the scope of the invention defined in the appended claims. For example, where specific dimensions are given, it will be understood that they are exemplary only and other dimensions are possible. As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A canine retrieving training system comprising:
a canine retrieving target comprising a target body and a target tether, the target tether being connected to the target body;
a target thrower comprising a handle and a throwing head supported by the handle, the throwing head including a tether receiver, the tether receiver being sized and shaped to receive the tether and configured to release the tether when the handle is moved in a throwing motion.

2. A canine retrieving training system as set forth in claim 1, wherein the tether receiver comprises a first arm and a second arm defining a slot therebetween sized and shaped for receiving the target tether therein.

3. A canine retrieving training system as set forth in claim 2, wherein the handle comprises an elongate shaft comprising a proximal portion, a distal portion, and a longitudinal axis extending therebetween, the throwing head being connected to the distal portion, the first and second arms extending distally with respect to the shaft.

4. A canine retrieving training system as set forth in claim 2, wherein the target tether comprises a tie portion and an anchor, the tie portion being sized to be receivable in the slot, the arms at least partially defining an anchor recess in front of the slot, the anchor recess being sized and shaped to receive the anchor when the tie portion is in the slot.

5. A canine retrieving training system as set forth in claim 4, wherein the anchor and anchor recess are sized and shaped to permit pivoting of the anchor in the anchor recess as the tie portion moves in the slot.

6. A canine retrieving training system as set forth in claim 4, wherein the tether and throwing head are configured to permit pivoting of the anchor relative to the anchor recess, while the anchor is in the anchor recess, responsive to movement of the handle in the throwing motion.

7. A canine retrieving training system as set forth in claim 6, wherein the anchor has a convex arcuate outer surface portion and the first arm comprises a first concave arcuate surface portion at least partially defining the anchor recess, the first concave arcuate surface portion being configured to permit sliding of the convex arcuate outer surface portion on the first concave arcuate surface portion to permit said pivoting of the anchor relative to the anchor recess.

8. A canine retrieving training system as set forth in claim 7, wherein the second arm comprises a second concave arcuate surface portion at least partially defining the anchor recess, the second concave arcuate surface portion being configured to permit sliding of the convex arcuate outer surface portion on the second concave arcuate surface portion to permit said pivoting of the anchor relative to the anchor recess.

9. A canine retrieving training system as set forth in claim 4, wherein the throwing head comprises a first exit ramp configured to promote the anchor to exit the anchor recess responsive to movement of the handle in the throwing motion.

10. A canine retrieving training system as set forth in claim 9, wherein the throwing head includes a connector connecting the throwing head to the handle, the first arm extending distally away from the connector, the first exit ramp being located on the first arm and spaced distally from the connector.

11. A canine retrieving training system as set forth in claim 10, wherein the throwing head comprises a second exit ramp configured to promote the anchor to exit the anchor recess responsive to movement of the handle in the throwing motion, the second exit ramp being located on the second arm and spaced distally from the connector.

12. A canine retrieving training system as set forth in claim 4, wherein the first and second arms comprise respective first and second fingers protruding forward.

13. A canine retrieving training system as set forth in claim 2, wherein the first arm defines a first tether guide ramp and the second arm defines a second tether guide ramp, the first and second tether guide ramps defining a mouth configured to guide the tether into the slot.

14. A canine retrieving training system as set forth in claim 13, wherein the first and second tether guide ramps taper toward each other as the first and second tether guide ramps extend toward the slot.

15. A canine retrieving training system as set forth in claim 4, wherein the handle comprises an elongate shaft comprising a proximal portion, a distal portion, and a longitudinal axis extending therebetween, the throwing head being connected to the distal portion, the anchor and anchor recess being configured such that when the anchor is received in the anchor recess the anchor is intersected by the longitudinal axis of the shaft.

16. A canine retrieving target thrower for throwing a canine retrieving target including a target body and a target tether, comprising:
a handle; and
a throwing head supported by the handle, the throwing head including a tether receiver comprising a first arm and a second arm defining a slot therebetween for reception of the target tether, the tether receiver being configured to release the target tether from the slot when the handle is moved in a throwing motion.

17. A canine retrieving target thrower as set forth in claim 16, wherein the handle comprises an elongate shaft comprising a proximal portion, a distal portion, and a longitudinal axis extending therebetween, the throwing head being connected to the distal portion, the first and second arms extending distally with respect to the shaft.

18. A canine retrieving target thrower as set forth in claim 17, wherein the first and second arms at least partially define an anchor recess in front of the slot, the anchor recess being wider than the slot.

19. A canine retrieving target thrower as set forth in claim 18, wherein the first arm comprises a first concave arcuate surface portion at least partially defining the anchor recess.

20. A canine retrieving target thrower as set forth in claim 19, wherein the second arm comprises a second concave arcuate surface portion at least partially defining the anchor recess.

21. A canine retrieving target thrower as set forth in claim 20, wherein the anchor recess is semi-spherical.

22. A canine retrieving target thrower as set forth in claim 18, wherein the throwing head comprises a first exit ramp configured to promote exit of the tether from the anchor recess responsive to movement of the handle in the throwing motion.

23. A canine retrieving target thrower as set forth in claim 22, wherein the throwing head includes a connector connecting the throwing head to the handle, the first arm extending distally away from the connector, the first exit ramp being located on the first arm and spaced distally from the connector.

24. A canine retrieving target thrower as set forth in claim 23, wherein the throwing head comprises a second exit ramp configured to promote the tether to exit the anchor recess responsive to movement of the handle in the throwing motion, the second exit ramp being located on the second arm and spaced distally from the connector.

25. A canine retrieving target thrower as set forth in claim 18, wherein the first and second arms comprise respective first and second fingers protruding forward.

26. A canine retrieving target thrower as set forth in claim 16, wherein the first arm defines a first tether guide ramp and the second arm defines a second tether guide ramp, the first and second tether guide ramps defining a mouth configured to guide the tether into the slot.

27. A canine retrieving target thrower as set forth in claim 26, wherein the first and second tether guide ramps taper toward each other as the first and second tether guide ramps extend toward the slot.

28. A method of throwing a canine retrieving target, the method comprising:
connecting a tether of the canine retrieving target to a thrower;
moving the thrower in a throwing motion;
wherein moving the thrower in the throwing motion comprises:
changing an angle of the tether with respect to a shaft of the thrower while the canine retrieving target is connected to the thrower, and
releasing the tether from the thrower.
